(19) United States
(12) Patent Application Publication
(10) Pub. No.: US 2020/0362806 A1
(43) Pub. Date: Nov. 19, 2020

(54) MOTOR FOR STARTER OF INTERNAL COMBUSTION ENGINE

(71) Applicant: DENSO CORPORATION, Kariya-city (JP)

(72) Inventors: Hiroyuki KUBO, Kariya-city (JP); Tatsuya FUJITA, Kariya-city (JP)

(73) Assignee: DENSO CORPORATION, Kariya-city (JP)

(21) Appl. No.: 16/875,054

(22) Filed: May 15, 2020

(30) Foreign Application Priority Data
May 16, 2019 (JP) 2019-093189

(51) Int. Cl. F02N 11/02

(52) U.S. Cl. CPC F02N 11/02

(57) ABSTRACT

A motor used for a starter of an internal combustion engine includes a motor shaft; a slide bearing that rotatably supports the motor shaft; and a bearing support member that supports the slide bearing. The motor shaft includes a concave portion or a convex portion extending in a direction orthogonal to an axial direction, the concave portion and the convex portion each includes a first surface and a second surface which face each other and the slide bearing is configured to be divided into a plurality of sections in a circumferential direction or the axial direction of the motor, the slide bearing serves as a regulation member that regulates a deviation of the motor shaft in the axial direction by an engagement between the slide bearing with the concave portion or the convex portion.

### CROSS-REFERENCE TO RELATED APPLICATION

This application is based on and claims the benefit of priority from earlier Japanese Patent Application No. 2019-093189 filed May 16, 2019, the description of which is incorporated herein by reference.

### BACKGROUND

### Technical Field

The present disclosure relates to a motor used for staring an internal combustion engine.

### Description of the Related Art

For a starter for starting an internal combustion engine, a DC motor having a brush is used. In the DC motor, while being rotated, a deviation of the motor shaft in the axial direction may cause wear of the brush. This is unfavorable. In this respect, various configuration to avoid wear of brush has been developed.

### SUMMARY

The present disclosure has been achieved in light of the above-described circumstances and provides a motor capable of readily suppressing a deviation of the motor shaft in the axial direction thereof.

As a first aspect, a motor used for a starter of an internal combustion engine is provided. The motor includes: a motor shaft; a slide bearing that rotatably supports the motor shaft; and a bearing support member that supports the slide bearing. The motor shaft includes a concave portion or a convex portion extending in a direction orthogonal to an axial direction.

### BRIEF DESCRIPTION OF THE DRAWINGS

In the accompanying drawings:

FIG. 1 is a diagram showing an overall configuration of a starter according to an embodiment of the present disclosure;

FIG. 2 is an enlarged cross-sectional view of a rear end portion of a motor shaft;

FIG. 3 is a disassembled perspective view of a slide bearing before being assembled;

FIG. 4 is an enlarged cross-sectional view of the rear end portion of the motor shaft according to other embodiments;

FIG. 5 is an enlarged cross-sectional view of the rear end portion of the motor shaft according to other embodiments;

FIG. 6 is an enlarged cross-sectional view of the rear end portion of the motor shaft according to other embodiments;

FIG. 7 is an enlarged cross-sectional view of the rear end portion of the motor shaft according to other embodiments;

FIG. 8 is an enlarged cross-sectional view of the rear end portion of the motor shaft according to other embodiments;

FIG. 9 is an enlarged cross-sectional view of the rear end portion of the motor shaft according to other embodiments; and

FIG. 10 is an enlarged cross-sectional view of the rear end portion of the motor shaft according to other embodiments.

### DETAILED DESCRIPTION OF THE PREFERRED EMBODIMENTS

As a conventional DC motor, for example, German Patent Application Laid-Open Publication Number 102012205519 discloses a configuration of a DC motor in which an annular shaped groove is disposed in a motor shaft extending in the axial direction from a housing that covers the DC motor and a ring member is disposed in the groove to be fitted thereto, thereby regulating a deviation of the motor shaft in the axial direction.

According to the above-mentioned configuration in the patent literature, an end portion of the motor shaft in the axial direction is protruded externally during the manufacturing of the DC motor, and a C-ring is embedded to the annular shaped groove disposed in the protruded portion. Then, an adjustment is applied such that pulling force to the motor or pressing force of the motor shaft in one direction is applied to the C-ring, thereby reducing the deviation in the axial direction of the motor shaft. At this timing, since the motor shaft and the C-ring is protruded towards outside, an adjustment of pulling the shaft by the C-ring or pressing the shat by the C-ring (i.e. adjustment of an amount of regulation) can be applied after manufacturing. However, according to such a configuration, the number of components and assembly effort increase. Further, after assembling the motor shaft, the amount of regulation is adjusted so that adjustment man hours also increase, thereby increasing a manufacturing cost.

With reference to the drawings, embodiments of the present disclosure will be described.

### Embodiment

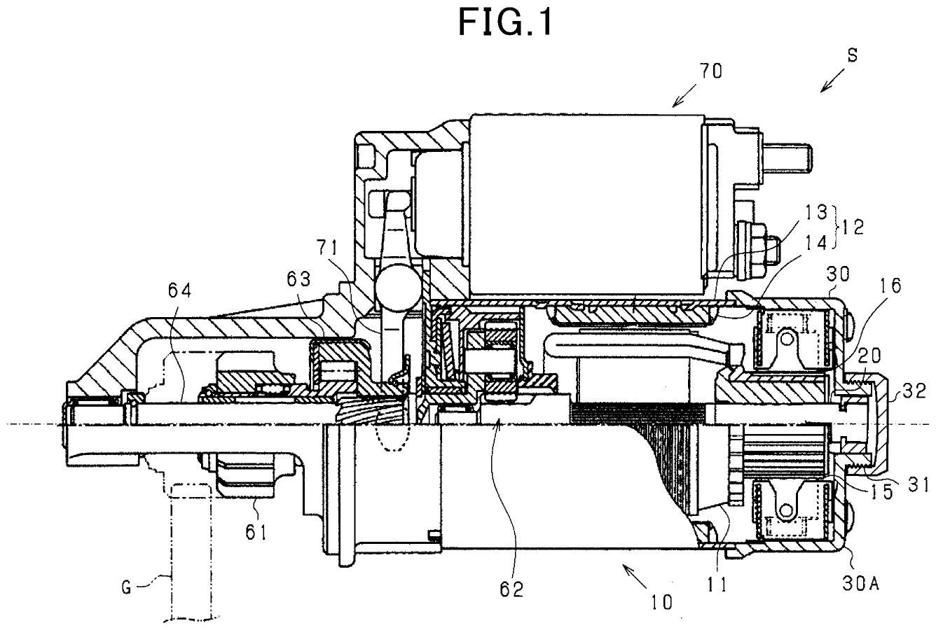

Hereinafter, with reference to the drawings, a configuration of a motor according to the present disclosure will be described, in which the motor is embodied as a DC motor used for a starter starting an internal combustion engine. FIG. 1 is an overall configuration of a starter S. The starter S is provided with a DC motor 10 as an example of a motor, a deceleration unit 62 that decelerates the rotation of the DC motor 10 and transmits the rotation to a pinion gear 61, and a magnet switch 70 used as a switch when supplying power to the DC motor 10.

The DC motor 10 is a DC motor having a known brush, and includes a rotor 11 as an armature, a stator 12 disposed in an outer periphery of the rotor 11. The rotor 11 is provided with a rotor core as an iron core, a coil wound around the rotor core, a commutator 15 connected to the coil, and a motor shaft 20 disposed in the center of the rotor 11.

In the commutator 15, the brush 16 slidably contacts with an outer periphery surface of the commutator 15. The commutator 15 is supplied with power from the battery via the brush 16, and the power supplied via the brush 16 is supplied to the coil.

The stator 12 is provided with a yoke 13 having a cylindrical shape, and a plurality of permanent magnets 14 as a magnet portion fixed to an inner periphery surface. A one end portion of the yoke 13 (end portion opposite to the pinion heat 61) is fixed to a rear cover 30. The permanent magnet 14 of the stator 12 is disposed around the rotor core facing the outer periphery surface of the rotor core. In the case where magnetic power is generated from the rotor core, the rotor 11 rotates relative to the stator 12.

The deceleration member 62 is disposed in an end portion of the motor shaft 20 in the pinion gear 61 side. The deceleration member 62 is configured by, for example, a planetary gear mechanism or the like. The motor shaft 20 of the DC motor 10 drives a drive shaft 64 to be decelerated via the deceleration member 62. The pinion gear 61 and a one way clutch 63 are attached to the drive shaft 64. The drive shaft 64 causes the pinion gear 61 to rotate in response to the rotation of the motor 20. Note that the motor shaft 20 of the DC power 10 may serve as a drive shaft without having a deceleration member 62 or the like.

The magnet switch 70 serves as a switch to produce a state where the starter S enables the ring gear G of the engine to rotate. For example, when an ignition (IG) switch is turned on due to a key operation by the user, by an operation of the magnet switch 70, a shift lever 71 pushes the pinion gear 61 out towards a portion opposite to the DC motor 10, whereby the pinion gear 61 meshes with the ring gear G. Further, the DC motor 10 is supplied with power via the magnet switch 70, then the rotation of the DC motor 10 is transmitted to the pinion gear 61 via the deceleration member 62 and the one way clutch 63.

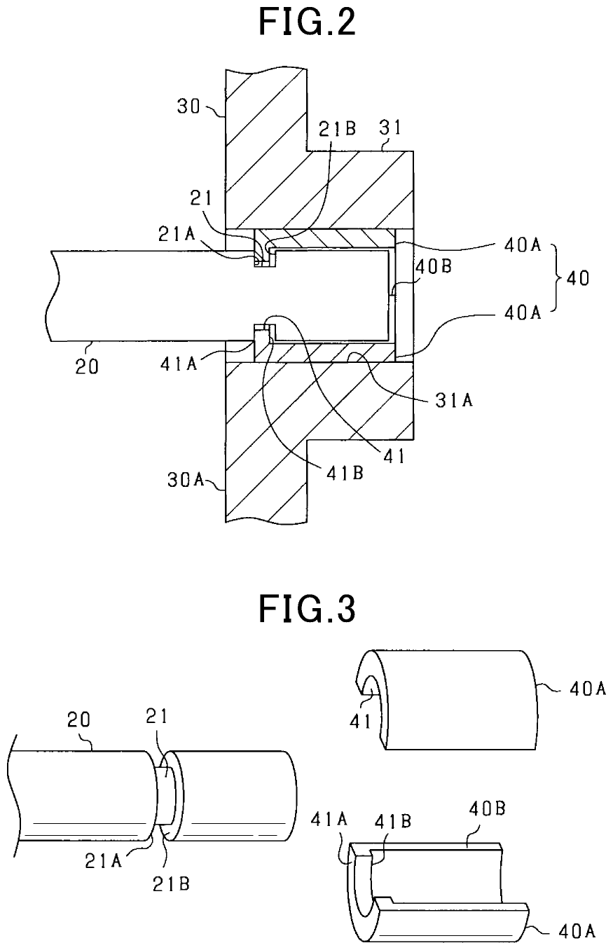

As shown in FIGS. 1 and 2, a configuration is utilized in order to suppress a deviation of the motor shaft 20 in the axial direction during the rotational state of the DC motor 10, in which a slide bearing 40 faces each of a first surface 21A and a second surface 21B of the motor shaft 20 in the axial direction so as to regulate the deviation in the axial direction of the motor 20. FIG. 2 illustrates an end portion (rear end portion) of the motor shaft 20 being positioned in the opposite side of the pinion gear 61. In the following description, the axial direction of the motor shaft 20 is defined as a front-back direction, and a left side portion in FIGS. 1 and 2, that is, a pinion gear 61 side, is defined as a front side.

The rear cover 20 covers the rear end portion of the DC motor 10 (i.e. end portion opposite to the pinion gear 61), and has a bottomed cylindrical shape. A cylindrical portion 31 that supports the slide bearing 40 is provided at a bottom portion 30A of the rear cover 30, that is, a rear end surface of the rear cover 30, having a surface being orthogonal to the motor shaft 20. Moreover, a cap 32 is attached to the cylindrical portion 31. The cap 32 covers an opening end (rear end portion) of the cylindrical portion 31 and attached to the cylindrical portion 31 by being screwed to the screw disposed in the outer periphery surface of the cylindrical portion 31. Note that the rear cover 30 may be integrated to the yoke 13 or may be integrated to the cap 32. The cylindrical portion 31 corresponds to Blearing support member.

The slide bearing 40 is press-fitted to the hole portion 31A of the cylindrical portion 31, which rotatably supports the motor shaft 20. The slide bearing 40 is configured to be divided into two portions in the circumferential direction at divided surface 40B which is a plane including the periphery of a center axis of the motor shaft 20 such that respective divided members 40A have the same shape. Further, the divided surface 40B of the slide bearing 40 are in parallel with respect to the axial direction. The slide bearing 40 has a cylindrical shape in a state where the divided members 40A are combined. The inner diameter (diameter of the hole portion 31A) of the slide bearing 40 in a state where the divided members 40A are combined, is slightly larger than the outer diameter of the motor shaft 20. The outer diameter of the slide bearing 40 is slightly larger than the inner diameter of the cylindrical portion 31.

In the slide bearing 40, a protrusion 41 having an annular shape is provided protruding towards an inner side of the radial direction at a front end portion of the slide bearing 40. The protrusion 41 is inserted into an annular concave portion 21 provided annularly extending along the outer periphery of the motor shaft 20. In order to allow the protrusion 41 to be inserted into the annular concave portion 21, the dimension of the annular concave portion 21 in the axial direction is set to be larger than the dimension of the protrusion 41 in the axial direction. Since the annular concave portion 21 may be provided to have a smaller diameter of the motor shaft 20 which is equivalent to the dimension of the protrusion 41 in the axial direction with which the protrusion is capable of inserting into the annular concave portion 21, a dimension in the axial direction a portion having a smaller diameter of the motor shaft 20 (annular concave portion 21) can be smaller.

Further, among wall surfaces between both sides of the annular concave portion 21 in the axial direction, one wall surface is defined as a first surface 21A and the other wall surface is defined as a second surface 21B. The first surface 21A and the second surface 21B extend in a direction crossing the axial direction, that is, in a direction being orthogonal to the axial direction, and are oriented towards opposite directions to each other. In other words, the first surface 21A and the second surface 21B face each other. The protrusion 41 faces each of the first surface 21A and the second surface 21B in the axial direction. Specifically, end faces of the protrusion 41 in the axial direction are defined as a first opposing surface 41A and a second opposing surface 41B. The first opposing surface 41A and the second opposing surface 41B are in parallel with the first surface 21A and the second surface 21B in a state of being assembled.

The slide bearing 40 is attached to the motor shaft 20 in a state where the first opposing surface 41A and the second opposing surface 41B of the annular concave portion 21 face the first surface 21A and the second surface 21B of the protrusion 41 respectively. In a state where the slide bearing 40 is attached to the motor shaft 20, the protrusion 41 is engaged with the first surface 21A and the second surface 21B of the annular concave portion 21, and surfaces (first surface 21A and second surface 21B) extending in a direction orthogonal to the axial direction of the motor shaft 20 and the slide bearing 40 face each other in the axial direction at two or more portions. Hence, the slide bearing 40 and the motor shaft 20 are engaged in the axial direction, whereby a deviation of the motor shaft 20 in the axial direction can be suppressed.

Next, with reference to FIGS. 2 and 3, assembling the slide bearing 40 with the motor shaft 20, and assembling the slide bearing 40 to the cylindrical portion 31, will be described. FIG. 3 is a disassembled perspective view showing a rear end portion of the motor shaft 20 in a state before the slide bearing 40 is assembled.

The divided members 40A of the slide bearing 40 are divided in the circumferential direction, thereby being attached to the motor shaft 20 in a state where the protrusion 41 faces, from the outer circumferential side, each of the first surface 21A and the second surface 21B of the annular concave portion 21 in the axial direction. Then, the motor shaft 20 and the slide bearing 40 are press-fitted to the hole portion 31A in a state where the slide bearing 40 is attached to the motor shaft 20. The slide bearing 40 is press-fitted within the cylindrical portion 31, whereby the slide bearing 40 can be fixed being assembled to the motor shaft 20.

Since the protrusion 41 of the slide bearing 40 is configured to face each of the first surface 21A and the second surface 21B of the annular concave portion 21 in the axial direction, a deviation of the motor shaft 20 in the axial direction can be suppressed by the engaging between the protrusion 41 of the slide bearing 40 and the annular concave portion 21 of the motor shaft 20. Further, unlike the conventional technique, without a regulation member provided at a portion protruding from the slide bearing 40, the slide bearing 40 suppresses the deviation of the motor shaft in the axial direction. Thus, the dimension of a portion protruding towards rear side of the motor 20 and the dimension of the DC motor 10 in the front-back direction can be smaller, while suppressing a deviation of the motor shaft 20 in the axial direction.

Moreover, a deviation of the motor shaft 20 in the axial direction is produced when the rotor 11 moves along the axial direction while the DC motor 10 rotates. Specifically, movement force along the axial direction is generated for the rotor 11 in response to the rotation of the DC motor 10 so as to cause a deviation of the motor shaft 20 in the front-back direction along the axial direction. A direction of either front or back direction along which the rotor 11 moves can be determined by an offset in the axial direction between the permanent magnet 14 and the rotor 11. Here, an offset is applied in the axial direction between the permanent magnet 14 and the rotor 11 in the DC motor 10 by adjusting the position of the slide bearing 40 in the axial direction within the cylindrical portion 31, whereby the movement direction of the rotor 11 can be set. For example, the position of the slide bearing 40 in the axial direction is adjusted within the cylindrical portion 31 such that the rotor 11 is relatively offset towards rear side with respect to the permanent magnet 14, the rotor 11 moves forward. Then, the slide bearing 40 is used as a regulation member that regulates a deviation of the motor shaft 20 in the axial direction and the position of the slide bearing 40 in the axial direction is adjusted within the cylindrical portion 31, whereby a movement direction of the rotor 11 in accordance with the position of the slide bearing 40 in the axial direction, that is, a deviation direction of the motor shaft 20, can be determined. Thus, the deviation of the motor shaft 20 caused by assembling the slide bearing 40 and the motor shaft 20 can be suppressed.

According to the above-described embodiment, the following effects and advantages can be obtained.

The slide bearing 40 serves as a regulation member that regulates a deviation of the motor 20 in the axial direction. Hence, the slide bearing 40 engages with the motor shaft 20 in the axial direction, whereby a deviation of the motor 20 in the axial direction can be suppressed. Moreover, in a configuration in which the slide bearing 40 regulates a deviation of the motor shaft 20 in the axial direction, the slide bearing 40 is divided into a plurality of sections in the circumferential direction, whereby assembling the slide bearing 40 can be accomplished under a state where the concave portion disposed in the motor shaft 20 is sandwiched. As described, the motor shaft 20 and the slide bearing 40 suppresses the deviation of the motor 20 in the axial direction, whereby a dedicated member for regulating a deviation of the motor shaft 20 in the axial direction is not necessary. As a result, the number of components can be reduced and the number of assembling steps can be reduced.

Further, according to the present embodiment, the slide bearing 40 is used as a regulation member that regulates a deviation of the motor shaft 20 in the axial direction and the position of the slide bearing 40 in the axial direction is adjusted within the cylindrical portion 31, whereby an offset can be applied between the permanent magnet 14 and the rotor 11 in the axial direction. By applying the offset, a movement direction of the rotor 11 in accordance with the position of the slide bearing 40 in the axial direction, that is, a deviation direction of the motor shaft 20, can be determined. Thus, deviation of the motor shaft 20 caused by assembling the slide bearing 40 and the motor shaft 20 can be suppressed.

The slide bearing 40 is configured to be divided into a plurality of sections at the divided surface 40B including the center axis of the motor shaft 20, and the protrusion 41 engages with the annular concave portion 21 provided in the motor shaft 20. The protrusion 41 of the slide bearing 40 and the annular concave portion 21 are engaged in the axial direction to assemble the slide bearing 40, thereby suppressing the deviation of the motor axis 20 in the axial direction.

### OTHER EMBODIMENTS

The present embodiment is not limited to the above-described embodiment, but may be embodied in the followings. Hence, the following examples of configurations may be applied to the above-described embodiment, or another examples of configurations may be arbitrarily combined.

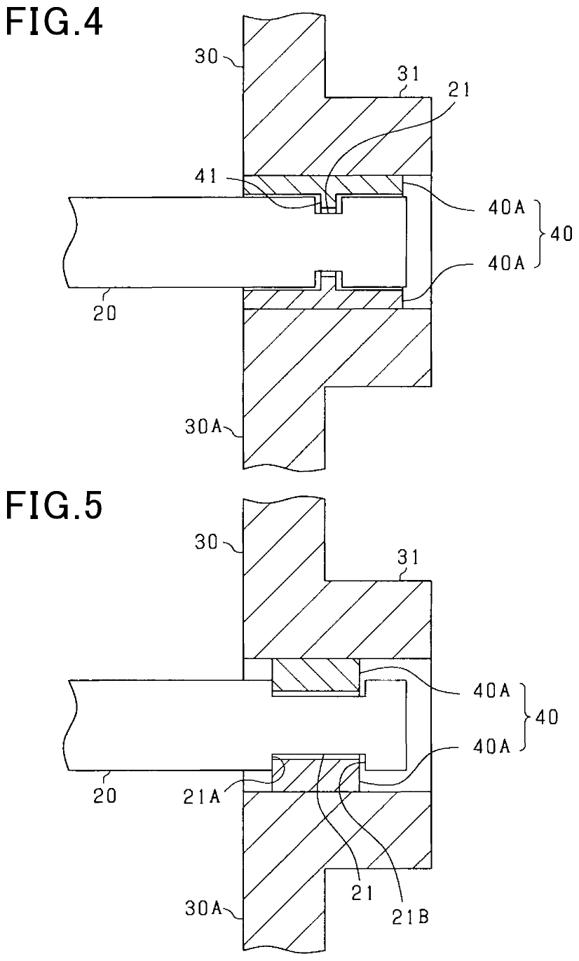

As shown in FIG. 4, the protrusion 41 of the slide bearing 40 may be provided at arbitrary positions in the axial direction. In this case, the annular concave portion 21 may be provided at a position being aligned to the protrusion 41.

As shown in FIG. 5, entire slide bearing 40 may be inserted into the annular concave portion 21 of the motor shaft 20. In this case, end faces of the slide bearing 40 in the axial direction face the first surface 21A and the second surface 21B of the annular concave portion 21.

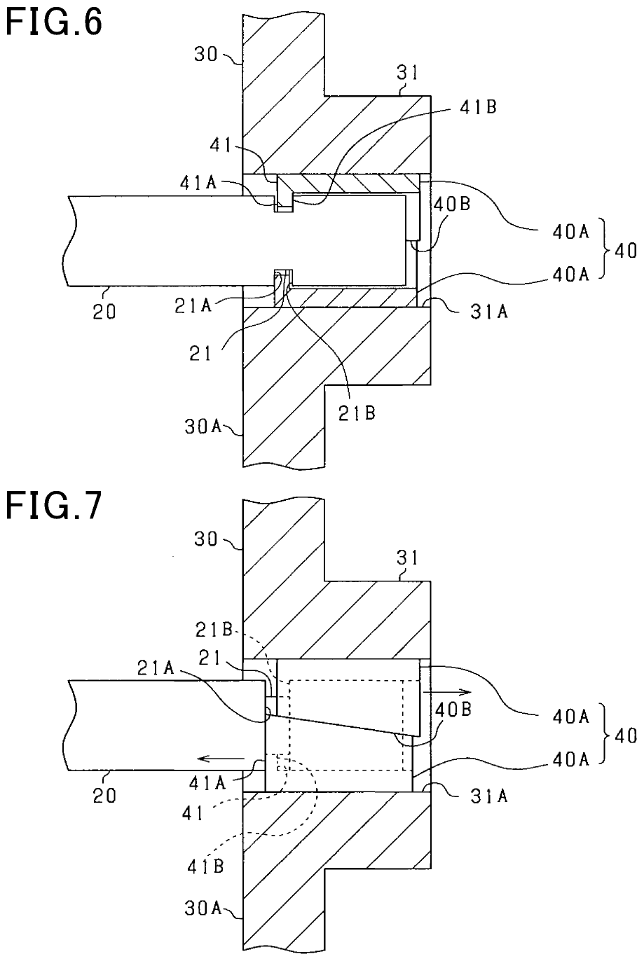

As shown in FIG. 6, the slide bearing 40 may be configured to be attached to the motor shaft 20 in a state where the respective two divided members 40A are mutually shifted in the axial direction. More preferably, the first opposing surface 41A of the protrusion 41 of the slide bearing 40 comes into contact with the first surface 21A and the second opposing surface 41B comes into contact with the second surface 21B.

In the motor shaft 20, the dimension of the annular concave portion 21 in the axial direction is larger than that of a portion in the slide bearing 40 protruding into the annular concave portion 21 (i.e. protrusion 41). Hence, a clearance may be present between the first surface 21A and the second surface 21B of the annular concave portion 21, and the slide bearing 40. In this case, respective divided members 40A are mutually shifted in the slide bearing 40, whereby the clearance between the first surface 21A and the second surface 21B of the annular concave portion 21, and protrusion 41 of the slide bearing 40 can be narrowed so that the deviation of the motor shaft 20 in the axial direction 20 can be further suppressed.

As shown in FIG. 7, the divided surface 40B of the slide bearing 40 may be inclined relative to the axial direction as an inclined surface. Note that the arrow in FIG. 7 shows a direction along which the respective divided members 40A of the slide bearing 40 are shifted.

In the case where the slide bearing 40 is press-fitted into the hole portion 31A, the slide bearing 40 receives force in the radial direction. At this moment, when the slide bearing 40 is divided in the circumferential direction at the divided surface 40B which is inclined relative to the axial direction, that is, when the divided surface 40B is configured as a linear inclined surface being oblique with respect to the axial direction, respective divided members 40A are mutually shifted in the axial direction at the divided surface 40B of the slide bearing 40 so as to transfer the received force towards the radial direction. Then, when the received force in the axial direction is large enough, the first opposing surface 41A of the protrusion 41 comes into contact with the first surface 21A, and the second opposing surface 41B comes into contact with the second surface 21B and then the slide bearing is stopped. It should be noted that an inclined angle of the divide surface 40B may preferably be set such that the inner diameter of the slide bearing 40 in state where the respective divided members 40A are mutually shifted in the axial direction, is larger than the outer diameter of the motor shaft 20. In other words, even in a state where the respective divided members 40A are mutually shifted in the axial direction, it is preferable that a gap is formed between the slide bearing 40 and the motor shaft 20, and the side bearing 40 supports the motor shaft 20 to be capable of rotating.

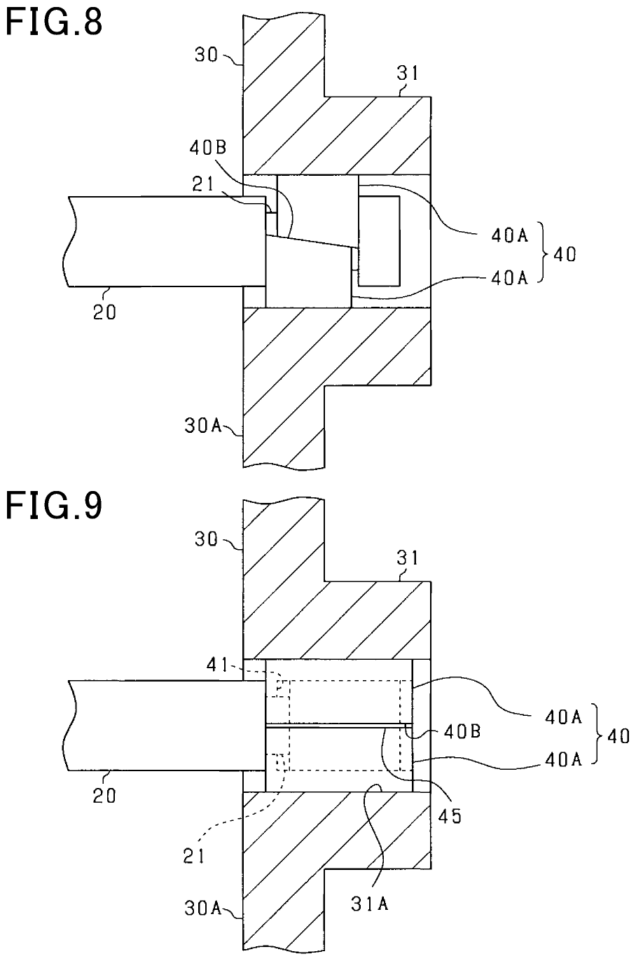

Thus, only with the press-fitting of the slide bearing 40 being attached to the motor 20, the respective divided members 40A of the slide bearing 40A are shifted to narrow the clearance in the axial direction between the first surface 21A, the second surface 21B of the annular concave portion 21, and the slide bearing 40. Moreover, as shown in FIG. 8, entire slide bearing 40 may be inserted into the annular concave portion 21 with the divided surface 40B being oblique relative to the axial direction.

As shown in FIG. 9, an elastic member 45 may be disposed between the respective divided surfaces 40B of the slide bearing 40. The elastic member 45 is disposed between the respective divided surfaces 40B of the slide bearing 40, whereby the elastic member 45 readily absorbs a tolerance of a fastening margin between the slide bearing 40 and the hole portion 31A of the cylindrical portion 31. When the force is applied in the radial direction by a press-fitting, the elastic member 45 is contracted. Hence, an insertion depth into the hole portion 31A can readily be adjusted so that the protrusion 41 is appropriately fastened. Thus, the deviation of the motor shaft 20 in the axial direction can be further reduced.

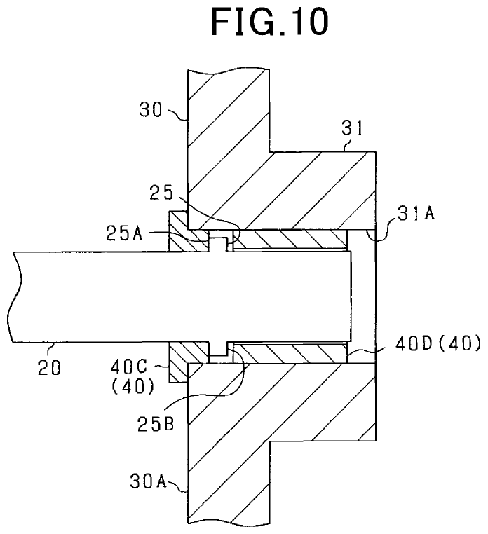

As shown in FIG. 10, the motor shaft 20 may include an annular convex portion 25 annularly extending along the outer periphery of the motor shaft 20 such that one surface in both surfaces of the annular convex portion 25 is defined as the first surface 25A, and the other surface is defined as the second surface 25B. In other words, the first surface 25A and the second surface 25B of the annular convex portion 25 face each other. In this case, the slide bearing 40 is configured to be divided in the axial direction and attached to the motor shaft 20 in a state where the respective divided slide bearings 40 face the first surface 25A and the second surface 25B in the axial direction.

For one divided member 40C in which the slide bearing 40 is divided in the axial direction, the motor axis 20 is attached in advance. The one divided member 40C comes into contact with an outer periphery portion (bottom portion 30A of the rear cover 30) of the hole portion 31A so as to be positionally aligned. Also, the other divided member 40D divided in the axial direction is press-fitted into the hole portion 31A of the cylindrical portion 31. Then, the motor shaft 20 to which the one divided member 40C is attached is inserted into the other divided member 40D, and the first surface 25A and the second surface 25B of the annular convex portion 25 face the end faces of the respective divided members 40C and the 40D of the slide bearing 40. Thus, the slide bearing 40 is assembled with the motor shaft 20 such that the slide bearing 40 is engaged with the annular convex portion 25 in the axial direction, whereby a deviation of the motor shaft 20 in the axial direction can be suppressed.

Further, screws may be provided in the outer periphery surface of the slide bearing 40 to be screwed with screws provided in the hole portion 31A. In this case, preferably, they may be screwed in a state where the divided member 40A of the slide bearing 40 is assembled by a jig or the like. The screws allow the slide bearing 40 in the cylindrical portion 31 to be positionally aligned easily.

The first surfaces 21A and 25A and the second surfaces 21B and 25B may not orthogonally cross the axial direction. In this case, the first surfaces 21A, 25A and the second surfaces 21B, 25B may preferably be parallel with the opposing surface of the slide bearing 40.

The protrusion 41 may be provided not to have annular shape, but may be provided protruding on a part of periphery, that is, provided partially protruding on the same periphery. Also, the annular convex portion 25 may be provided not to have an annular shape, but may be provided protruding on a part of periphery, that is, provided partially protruding on the same periphery.

### CONCLUSION

The present disclosure provides a motor capable of readily suppressing a deviation of the motor shaft in the axial direction thereof.

As a first aspect, a motor (10) used for a starter (S) of an internal combustion engine is provided. The motor includes: a motor shaft (20); a slide bearing (40) that rotatably supports the motor shaft; and a bearing support member (31) that supports the slide bearing. The motor shaft includes a concave portion (21) or a convex portion (25) extending in a direction orthogonal to an axial direction, the concave portion and the convex portion each includes a first surface (21A, 25A) and a second surface (21B, 25B) which face each other; and the slide bearing is configured to be divided into a plurality of sections in a circumferential direction or the axial direction of the motor, the slide bearing serves as a regulation member that regulates a deviation of the motor shaft in the axial direction by an engagement between the slide bearing with the concave portion or the convex portion.

The slide bearing is capable of suppressing the deviation of the motor shaft in the axial direction by the engaging between the slide bearing and the annular concave portion or the annular convex portion of the motor shaft. Further, the slide bearing is divided into a plurality of portions in a configuration in which the slide bearing regulates the deviation of the motor shaft in the axial direction, whereby the slide bearing is assembled to engage with the concave portion or the convex portion provided in the motor shaft. As described, the motor shaft together with the slide bearing suppresses the deviation of the motor shaft in the axial direction, whereby a dedicated member for regulating a deviation of the motor shaft in the axial direction is not necessary. As a result, the number of components can be reduced and the number of assembling steps can be reduced.

Moreover, the deviation of the motor shaft in the axial direction is produced when the rotor moves along the axial direction while the motor rotates. A direction of either front or back direction along which the rotor moves can be determined by an offset in the axial direction between the permanent magnet and the rotor. Here, an offset is applied in the axial direction between the permanent magnet and the rotor in the motor by adjusting the position of the slide bearing in the axial direction, whereby the movement direction of the rotor can be set. According to the present disclosure, the slide bearing is used as a regulation member that regulates a deviation of the motor shaft in the axial direction and the position of the slide bearing in the axial direction is adjusted within the bearing support member, whereby a movement direction of the rotor in accordance with the position of the slide bearing in the axial direction, that is, a deviation direction of the motor shaft, can be determined. Thus, the deviation of the motor shaft caused by assembling of the slide bearing and the motor shaft can be suppressed.

As a second aspect, the motor shaft includes the concave portion (21) having an annular shape, among wall surfaces between both sides of the annular concave portion in the axial direction, one wall surface is defined as a first surface (21A) and the other wall surface is defined as a second surface (21B); and the slide bearing includes a protrusion (41) that is engaged with the concave portion, the slide bearing being divided into a plurality of divided portions circumferential direction at a plane (40B) including a center axis of the motor shaft.

The slide bearing is configured to be divided into a plurality of portions in the circumferential direction in a plane including the periphery of a center axis of the motor shaft such that the protrusion is engaged with the concave portion provided in the motor shaft. The slide bearing is assembled such that the protrusion of the slide bearing and the concave portion of the motor shaft are engaged in the axial direction, whereby the deviation of the motor shaft in the axial direction can be suppressed.

As a third aspect, each of the divided portions of the slide bearing includes the protrusion, the slide bearing is attached to the motor shaft in a state where the respective divided portions are mutually shifted in the axial direction.

The dimension of the concave portion in the axial direction is larger than the dimension of the protrusion of the slide bearing in the axial direction. Hence, a clearance is present between the first surface, the second surface of the concave portion, and the protrusion. In this case, respective portions are mutually shifted in the slide bearing, whereby the clearance between the first surface, the second surface, and protrusion of the protrusion can be narrowed so that the deviation of the motor shaft in the axial direction can be further suppressed.

As a fourth aspect, the bearing support member includes a hole portion (31A) to which the slide bearing is press-fitted; the motor shaft includes the concave portion having an annular shape, and among wall surfaces between both sides of the annular concave portion in the axial direction, one wall surface is defined as a first surface (21A) and the other wall surface is defined as a second surface (21B); and the slide bearing is divided in the circumferential direction at a surface (40B) inclined relative to the axial direction.

In the case where the slide bearing is press-fitted into the hole portion provided in the bearing support member, the slide bearing receives force in the radial direction. At this moment, when the slide bearing is divided in the circumferential direction at the divided surface which is inclined relative to the axial direction, respective divided portions are mutually shifted in the axial direction so as to transfer the received force towards the radial direction. Thus, only with the press-fitting of the slide bearing being attached to the motor, the respective divided portions of the slide bearing are shifted to narrow the clearance in the axial direction between the first surface, the second surface of the concave portion, and the slide bearing. It should be noted that an inclined angle of the divide surface may preferably be set such that the inner diameter of the slide bearing in state where the respective divided portions are shifted in the axial direction, is larger than the outer diameter of the motor shaft. In other words, even in a state where the respective divided portions are shifted in the axial direction, it is preferable that a gap is formed between the slide bearing and the motor shaft, and the side bearing supports the motor shaft to be capable of rotating.

As a fifth aspect, the motor shaft includes the convex portion (25) in an outer periphery thereof, and among wall surfaces between both sides of the annular concave portion in the axial direction, one wall surface is defined as a first surface (25A) and the other wall surface is defined as a second surface (25B); and the slide bearing is configured to be divided in the axial direction, the slide bearing being attached to the motor shaft in a state where the divided slide bearings face the first surface and the second surface respectively in the axial direction.

The slide bearing is configured to be divided into a plurality of portions in the axial direction, and divided slide bearings are attached to the motor shaft in a state where the divided slide bearings face the first surface and the second surface respectively in the axial direction. The first and second surfaces are wall surfaces of the convex portion in the both sides thereof in the axial direction. The slide bearing is assembled such that the slide bearing and the convex portion of the motor shaft are engaged, whereby the deviation of the motor shaft in the axial direction can be suppressed. Note that the convex portion may be provided annularly in the circumferential direction or partly provided in the circumferential direction.

What is claimed is:

1. A motor used for a starter of an internal combustion engine comprising:
a motor shaft;
a slide bearing that rotatably supports the motor shaft; and
a bearing support member that supports the slide bearing, wherein
the motor shaft includes a concave portion or a convex portion extending in a direction orthogonal to an axial direction, the concave portion and the convex portion each includes a first surface and a second surface which face each other;
the slide bearing is configured to be divided into a plurality of sections in a circumferential direction or the axial direction of the motor, and
the slide bearing serves as a regulation member that regulates a deviation of the motor shaft in the axial direction by an engagement between the slide bearing with the concave portion or the convex portion.

2. The motor according to claim 1, wherein
the motor shaft includes the concave portion having an annular shape, and among wall surfaces between both sides of the annular concave portion in the axial direction, one wall surface is defined as a first surface and the other wall surface is defined as a second surface; and
the slide bearing includes a protrusion that is engaged with the concave portion, the slide bearing being divided into a plurality of divided portions circumferential direction at a plane including a center axis of the motor shaft.

3. The motor according to claim 2, wherein
each of the divided portions of the slide bearing includes the protrusion, the slide bearing being attached to the motor shaft in a state where the respective divided portions are mutually shifted in the axial direction.

4. The motor according to claim 1, wherein
the bearing support member includes a hole portion to which the slide bearing is press-fitted;
the motor shaft includes the concave portion having an annular shape, and among wall surfaces between both sides of the annular concave portion in the axial direction, one wall surface is defined as a first surface and the other wall surface is defined as a second surface; and
the slide bearing is divided in the circumferential direction at a surface inclined relative to the axial direction.

5. The motor according to claim 1, wherein
the motor shaft includes the convex portion in an outer periphery thereof, and among wall surfaces between both sides of the annular concave portion in the axial direction, one wall surface is defined as a first surface and the other wall surface is defined as a second surface; and
the slide bearing is configured to be divided in the axial direction, the slide bearing being attached to the motor shaft in a state where the divided slide bearings face the first surface and the second surface respectively in the axial direction.
